(19) United States
(12) Patent Application Publication
(10) Pub. No.: US 2013/0256202 A1
(43) Pub. Date: Oct. 3, 2013

(54) Water Recycling Unit

(71) Applicant: Timothy Gordon Smith, Lyalta (CA)

(72) Inventor: Timothy Gordon Smith, Lyalta (CA)

(21) Appl. No.: 13/851,867

(22) Filed: Mar. 27, 2013

Related U.S. Application Data
(60) Provisional application No. 61/616,122, filed on Mar. 27, 2012.

(51) Int. Cl. B01D 35/04

(52) U.S. Cl. CPC B01D 35/04
USPC 210/136; 210/416.1

(57) ABSTRACT

A water recycling unit for use with a sink comprising a pump which is connected to an upper tube on an exit port of the pump and a lower tube connected to the entry port of the pump. A water recycling unit for use with a sink is provided such that water can be re-used during the rinsing of dishes or any other product being washed in a sink. A water recycling unit for use with a sink that is portable is also provided for easy adaptability to any sink.

### CLAIM OF PRIORITY

The present application for patent claims priority to U.S. Provisional Patent Application No. 61/616,122 entitled “Water Recycling Unit” filed Mar. 27, 2012, the entire disclosure of which is hereby expressly incorporated by reference herein.

### BACKGROUND

1. Field

The invention relates to a water recycling unit and, more specifically, a water recycling unit for general use in sinks.

2. Background

Recently, people are becoming more and more water conscious given its constantly increasing price. New shower heads, kitchen faucets, garden hoses and other water dispensing devices have been and are still being designed to maximize water contact while minimizing water consumption.

In the ongoing trend towards economizing water, various devices have been invented to reuse or recycle water. Examples of such devices include U.S. Pat. Nos. 6,481,028 (Hsia), U.S. Pat. No. 5,353,448 (Lee) and U.S. Pat. No. 5,293,654 (Castwall et al.) whereby some of the used water from the shower is recycled to be later used elsewhere or in the same shower. Indeed, the drain collects the water and can filter or dispense of the dirty water according to the operator.

Similarly, other devices have been invented and utilized in order to recycle fluids for the purposes of cleaning or oiling various objects. Specifically, with regards to U.S. Pat. No. 4,897,202 (King), King discloses a device to recycle lubricants so as to reduce the waste of the lubricant. The piece is lubricated, put on a conveyor belt, and a suction bar recovers part of the lubricant for other parts. The system repeats itself to save fluids.

Other devices, such as those from U.S. Pat. No. 7,100,636 (King) are utilized in order to recycle water that is not useful at a certain temperature. Should an operator require very hot or very cold water, the operator simply moves a nozzle in one direction or another to change the direction of the water, the remainder of which is sent back to the source so as to limit waste.

Today, one of the most wasteful uses of water, whether hot or cold, is the rinsing of dishes after a manual wash as well as for the washing dishes. For rinsing dishes, the water is either left on constantly, filing up the washing sink and subsequently rinsing the dishes, or turned on and off after every dish. Unfortunately, none of the aforementioned devices or systems can provide a solution to this problem. A very small amount of water needs to be provided so as to constantly recycle itself for the duration of the washing of the dishes. The present device addresses this problem: it recycles the amount of water located at the bottom of the sink to rinse off most of the soap from the dishes. The present invention also allows for it to be used for washing dishes as well by recycling the soapy water used to wash dishes in a sink.

### SUMMARY

One feature pertains to a mobile water recycling unit for use with a sink comprising a pump having an entry port and an exit port, an upper tube having a spout operatively connected to the exit port and a lower tube having a filter operatively connected to the entry port of the pump wherein water travels from the filter to the lower tube, through the pump, into the upper tube and through to the spout.

Another feature pertains to a water recycling unit for use with a sink comprising a pump having an entry port and an exit port, an upper tube having a spout operatively connected to the exit port and a lower tube having a filter operatively connected to the entry port of the pump wherein water travels from the filter to the lower tube, through the pump, into the upper tube and through to the spout.

According to one aspect, the upper tube is operatively connected to the exit port through an upper lock nut and a J-tube. According to another aspect, the lower tube is operatively connected to the entry port through a lower lock nut and an L-tube. According to yet another aspect, the water recycling unit and/or the mobile water recycling unit further comprises a check valve to allow water to pass through the pump. According to one aspect, the water recycling unit and/or the mobile water recycling unit further comprises a check valve to preserve water in the pump. According to another aspect, the filter further comprises a filter element to filter smaller debris. According to yet another aspect, the filter further comprises a filter cage to filter larger debris.

According to one aspect, the pump is non-submersible. According to another aspect, the pump is submersible.

### BRIEF DESCRIPTION OF THE DRAWINGS

The following figures serve to illustrate various embodiments of features of the invention. These figures are illustrative and are not intended to be limiting.

FIG. 1 is a side view illustrative of one embodiment of a water recycling unit.

FIG. 2 is a perspective view illustrative of one embodiment of a water recycling unit.

FIGS. 3 and 4 are side views illustrative of one embodiment of a water recycling unit without its housing.

FIG. 5 is a cross-sectional perspective view of a submersible pump as described within a water recycling unit.

FIG. 6 is a cross-sectional perspective view of a submersible pump with upper and lower tubes as described within a water recycling unit.

FIG. 7 is a perspective view of an upper tube as described within a water recycling unit.

FIG. 8 is a perspective view of a lower tube as described within a water recycling unit.

FIG. 9 is a side view of a filter unit as described within a water recycling unit.

### DETAILED DESCRIPTION

The present invention will now be described more fully hereinafter with reference to the accompanying drawings, in which preferred embodiments of the present invention are shown. The following embodiments are merely illustrative and are not intended to be limiting. It will be appreciated that various modifications and/or alterations to the embodiments described herein may be made without departing from the invention and any modifications and/or alterations are within the scope of the contemplated invention.

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, or that the two or more elements co-operate or interact with each other (e.g. as in a cause and effect relationship).

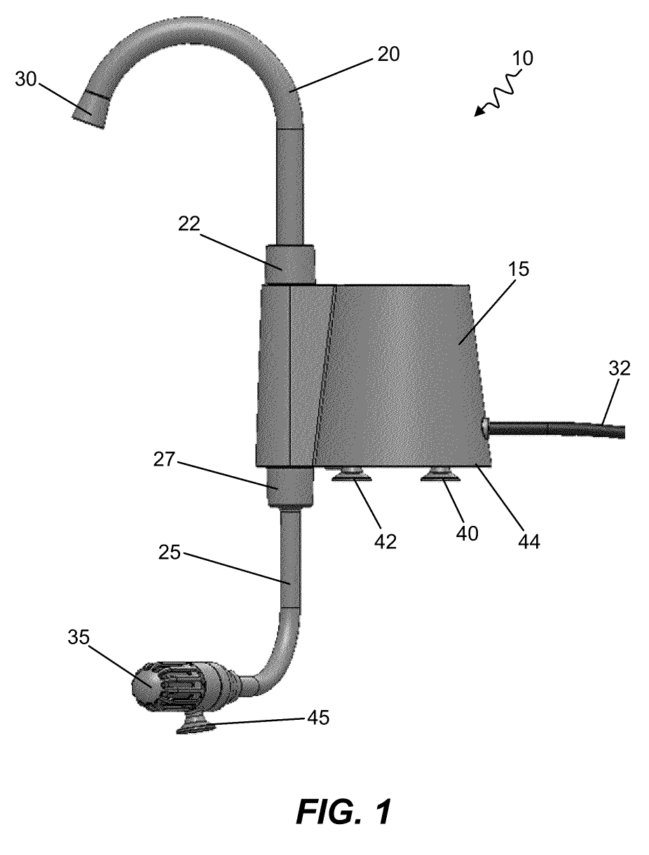

With reference to FIG. 1 and according to one embodiment of the present invention, a mobile water recycling unit 10 is shown. The water recycling unit 10 is comprised of a housing 15 which has a pump (not shown), and upper and lower tubes 20, 25. The pump has electrical and mechanical components and receives power from a power cord 32. The upper tube 20 has one end connected to an upper lock nut 22 which is fastened to the housing 15, while the opposite end is connected to a spout 30. The lower tube 25 has one end connected to a lower lock nut 27 which is fastened to the housing 15, while the opposite end is connected to a filter unit 35. The water recycling unit 10 is also comprised of housing suction cups 40, 42 positioned on the lower surface 44 of the housing 15, and a filter suction cup 45, positioned on the filter unit 35. In one embodiment, a total of four housing suction cups are positioned on the lower surface 44 of the housing 15, while one filter suction cup 45 is positioned on the filter unit 35. A worker skilled in the relevant would be familiar with various other types of securing means which could consist of suction cups, magnets, Velcro, etc. In another embodiment, the housing 15 and filter unit 35 could also have no securing means and could simply have a flat or ribbed surface, or be comprised of legs.

With further reference to FIG. 1, a check valve (not shown) could be installed at various locations within the water recycling unit 10. Specifically, a check valve could be installed within the lower tube 25 or in between the lower tube 25 and lower lock nut 27. A check valve could also be installed within the upper tube 25 or in between the upper tube 20 and the upper lock nut 22. A check valve could also be installed in between the upper lock nut 22 and the pump (not shown). A check valve could also be installed in between the lower lock nut 27 and the pump (not shown). A single or a number of check valves could be installed within the upper tube 20, upper lock nut 22, the pump (not shown), lower lock nut 27 and lower tube 25. A worker skilled in the relevant art would be familiar with the proper location of a check valve or check valves within the water recycling unit 10. The use of a check valve would allow for the retention of water within the water recycling unit 10 to facilitate any priming required of the unit.

With further reference to FIG. 1 and according to one embodiment of the present invention, the water recycling unit 10 of the present invention is portable and can be moved from one sink to another with relative ease. In another embodiment of the present invention, the water recycling unit 10 could be fixed to a surface or a sink.

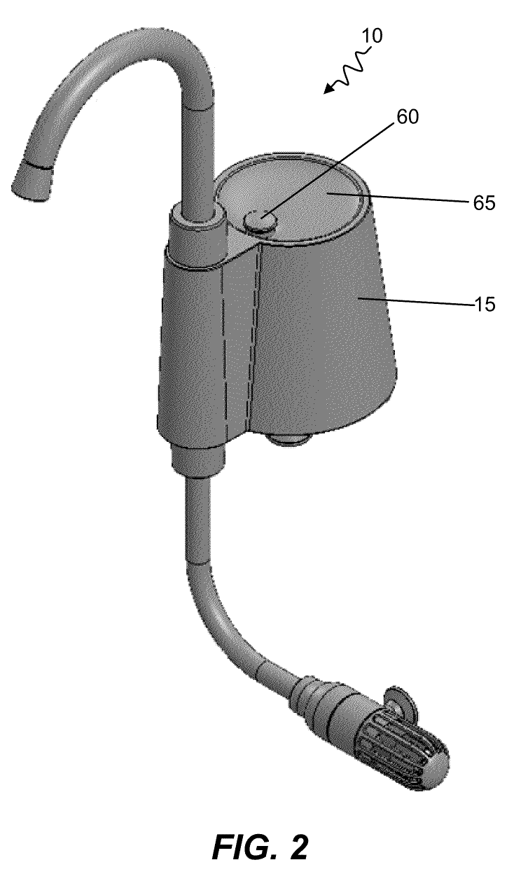

With reference to FIG. 2 and according to one embodiment of the present invention, a primer plug 60 is located on the upper surface 65 of the housing 15 of the water recycling unit 10. When the primer plug 60 is removed, water can be transported to an impeller (not shown) in the pump (not shown), which serves to help prime the pump and commence the water recycling process. The process is described in greater detail below.

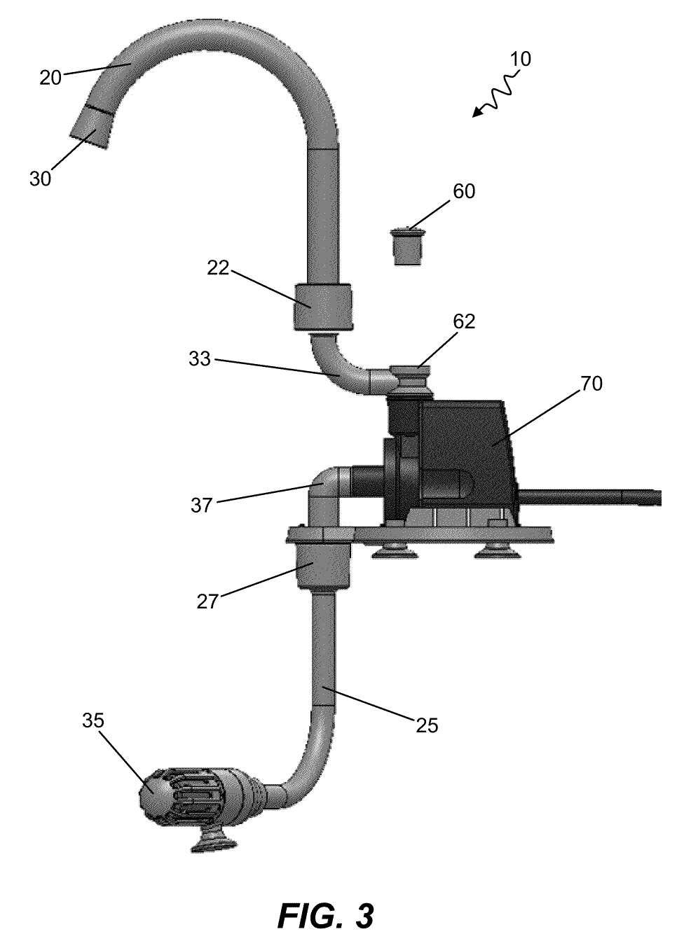

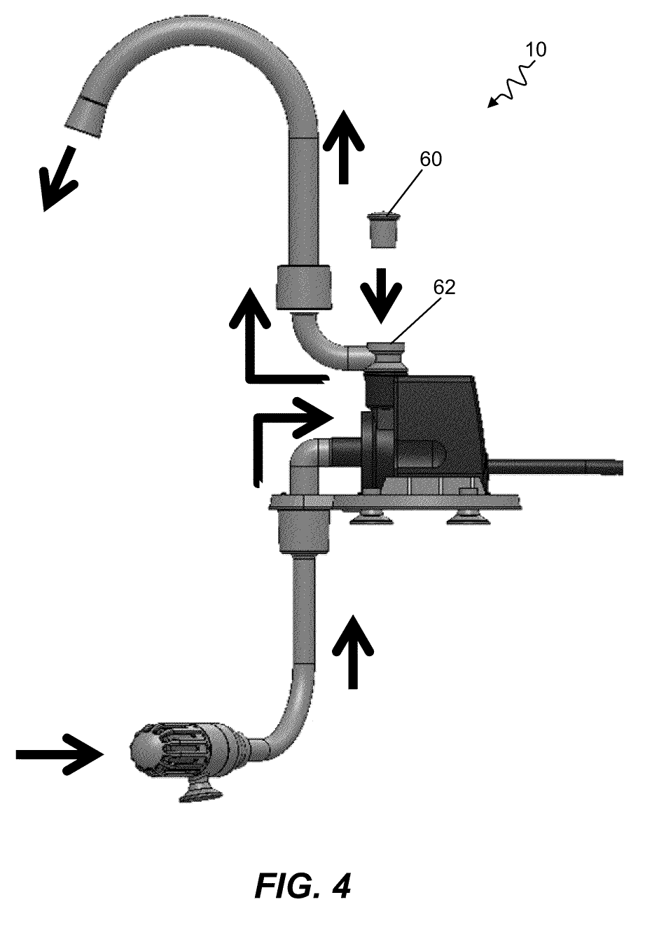

With reference to FIGS. 3 and 4 and according to one embodiment of the present invention, the water recycling unit 10 is shown without its housing. The upper tube 20 can be seen connected to the upper lock nut 22, which is in turn connected to an outlet J-tube 33. The outlet J-tube 33 is connected to an exit port (not shown) of pump 70. The use of upper lock nut 22 and outlet J-tube 33 operatively connects the upper tube 20 to the exit port (not shown) of the pump 70. The lower tube 25 can be seen connected to the lower lock nut 27, which is in turn fastened to an inlet L-tube 37. The inlet L-tube 37 is connected to an entry port (not shown) of pump 70. A worker skilled in the relevant art would be familiar with various types of fastening means to secure the upper and lower tubes 20, 25 to outlet J-tube 33 and inlet L-tube 37, respectively, i.e. by means of a screw, a nut, etc. The primer plug 60 is also shown removed from the upper surface of the housing (not shown) and can be mounted on upper aperture 62. Various arrows are also shown under FIG. 4, each arrow representing the direction of the flow of water through the water recycling unit 10.

With further reference to FIGS. 3 and 4 and according to one embodiment of the present invention, to activate the water recycling unit 10, the primer plug 60 is removed, a finite amount of water is poured into the upper surface of the housing (not shown) resulting in water traveling to primer aperture 62, and the primer plug 60 is returned to its original position on top of primer aperture 62. The pump 70 is then turned on by means of a switch (not shown) which electrically activates the impeller. The impeller begins to rotate, and the initial finite body of water within pump 70 rotates as well. A worker skilled in the relevant art will appreciate the fluid mechanics of the water recycling unit 10, whereby the initial turning of the impeller will create a suction force from the filter unit 35. Water located around the filter unit 35 will be suctioned through the filter unit 35 and into lower tube 25. From the lower tube 25, the water will proceed through inlet L-tube 37, entry port (not shown) and into pump 70. In turn, pump 70 will force the water up into exit port (not shown) and outlet J-tube 33, through to the upper tube 20. The water will then exit the upper tube 20 through the spout 30. The process will repeat itself as long as there is a sufficient amount of water around the filter unit 35 to continue creating a suction force and that the pump 70 is turned on. A worker skilled in the relevant art would be familiar with many types of pumps and impellers that could be utilized to create the required force necessary to continuously move water through the water recycling unit 10.

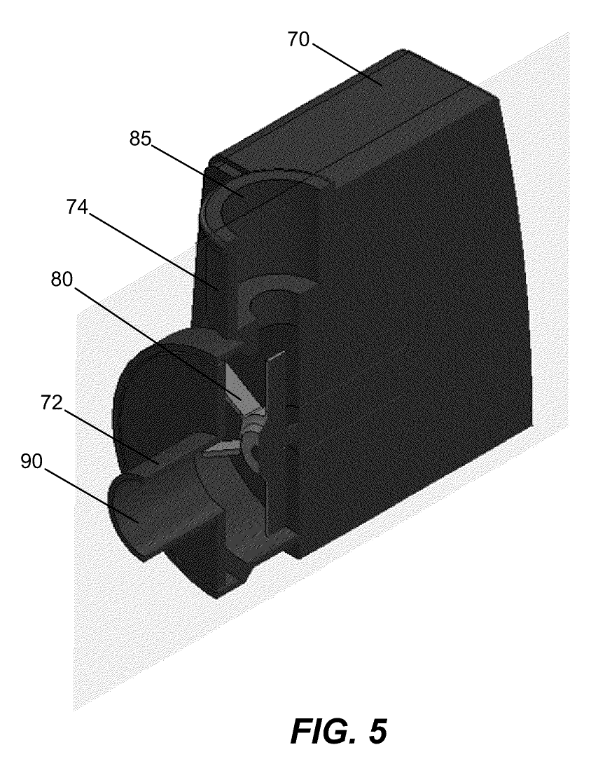

With reference to FIG. 5 and according to one embodiment of the present invention, pump 70 is shown in greater detail. A cross-section in the Y-Z plane of the pump 70 is shown to provide a view of an impeller 80. Initially, water flows from an upper aperture 85 of the exit port 74 in a downward motion toward the impeller 80. Once the impeller 80 begins to turn, it creates a suction force from a lower aperture 90 of the entry port 72. When the water arrives from the filter unit (not shown) of the lower tube (not shown) it is rotated upwards by the spinning motion of the impeller 80 and back through the upper aperture 85 of the exit port 74, and ultimately through to the spout (not shown) of the upper tube (not shown).

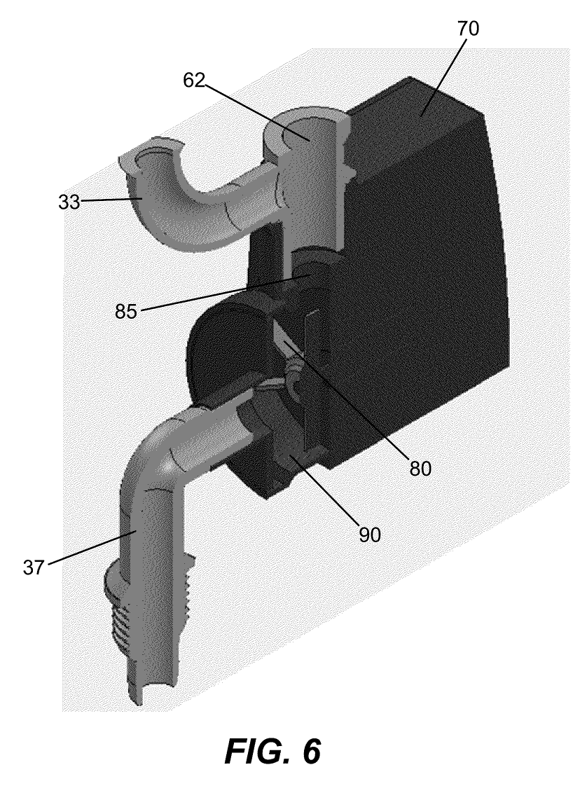

With reference to FIG. 6 and according to one embodiment of the present invention, the pump 70 is shown connected to J-tube 33 and L-tube 37. A cross-section in the Y-Z plane provides a view of the impeller 80. The primer plug is absent to illustrate the initial flow of water as described above. Once the initial finite amount of water has flown from the primer aperture 62 of the outlet J-tube 33 to the impeller 80, the primer plug (not shown) is replaced in its original position to seal the primer aperture 62. The water flow is thus restricted from the lower aperture 90 of the inlet L-tube 37, through to the upper aperture 85 of the outlet J-tube 33 and ultimately to the spout (not shown) of the upper tube (not shown).

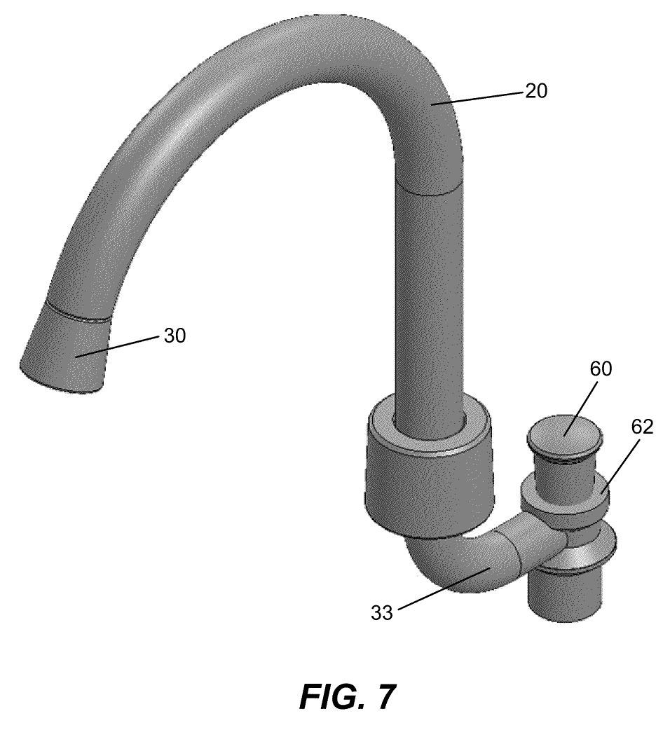

With reference to FIG. 7 and according to one embodiment of the present invention, the upper tube 20 is shown in greater detail. The upper lock nut 22 is shown connecting the outlet J-tube 33 to one end of the upper tube 20, and the other end of the upper tube 20 is connected to the spout 30. The primer plug 60 is shown plugged into the outlet J-tube 33 which has the primer aperture 62, which serves to restrict the water flow from the outlet J-tube 33, through to the upper tube 20 and ultimately out of the spout 30.

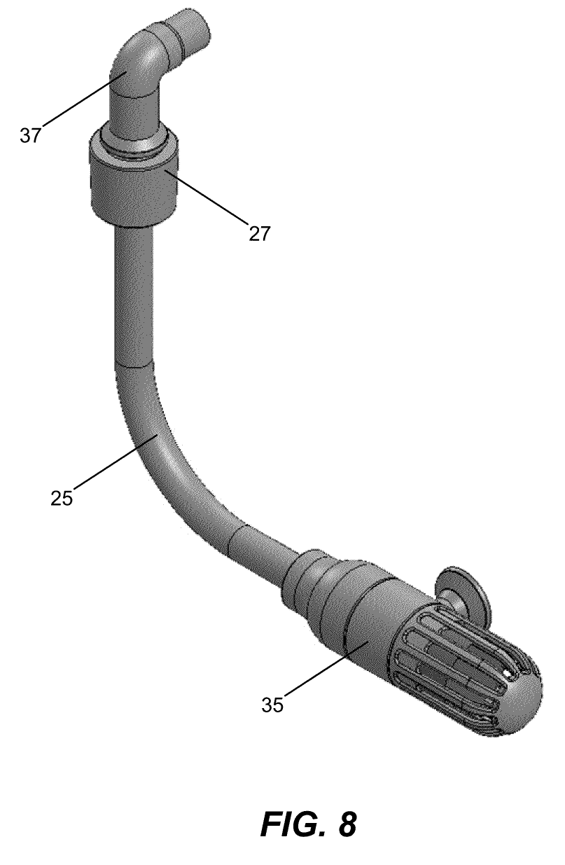

With reference to FIG. 8 and according to one embodiment of the present invention, the lower tube 25 is shown in greater detail. The lower lock nut 27 is shown connecting the inlet L-tube 37 to one end of the lower tube 25, and the other end of the lower tube 25 is connected to the filter unit 35. The water flow is restricted from going through filter unit 35, through to the lower tube 25 and through to the inlet L-tube 37.

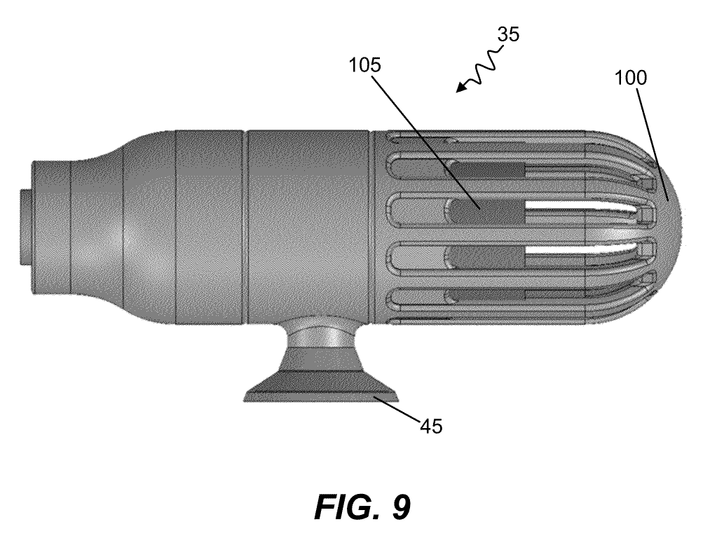

With reference to FIG. 9 and according to one embodiment of the present invention, the filter unit 35 connected to the filter suction cup 45 is shown in greater detail. A filter cage 100 is shown, which serves to restrict larger objects and various debris from entering a filter elements 105. The filter element 105 is utilized to filter smaller debris and the water itself. A worker skilled in the relevant art would be familiar with various types of filters that could be utilized in the water recycling unit 10. For example, small debris could defined as any debris that is smaller in volume than one cubic mm and whereas larger debris is defined as anything larger than one cubic millimeter.

In another embodiment of the present invention, the pump could be self-priming such that it would not need an initial flow of water to activate it. A different type of pump could start itself electrically (i.e. by powering it on) and force the water flow. The powering mechanism could also be primed by an operator engaging a mechanical component, such as a crank, or other device known to those skilled in the relevant art to start the flow of water. A check valve could also be present within the unit to allow for the continual presence of water within the pumping chamber of the pump even when deactivated.

In another embodiment of the present invention, and utilizing any of the aforementioned priming mechanisms, the water recycling unit could be built into the sink itself. Indeed, the filter unit could be part of the basin of the sink, and connected to either the existing faucet or a separate faucet, such that the push of a button or other mechanism would activate a pump and filter the water and re-dispense it for the rinsing process.

In an alternative embodiment of the present invention, the water recycling unit is mounted under the sink wherein the filter unit is connected directly to the base of the sink which allows for water to enter a pressurized container and subsequently sent into the water recycling unit of the present invention. The pressurized container could progressively accumulate water and once a certain level within the container or pressure is attained, a bypass would be activated or a check valve would be activated stopping all water from accumulating within the pressurized container.

In a further alternative embodiment of the present invention, a flow regulator could be installed within the unit allowing for the increase or decrease of the flow. The regulator would be installed within the upper tube of the water recycling unit 10 or alternatively could be installed at the mouth of the upper aperture of the pump. The regulator could be manually controlled or electronically control via a button on the water recycling unit.

In a further alternative embodiment of the present invention, the pump could be connected to a water source such as the same source as for the sink or faucet wherein the present invention is utilized and with direct access to this water source provide a direct priming source for the pump upon activating the unit. A check valve could also be activated upon the pump being primed.

In a further alternative embodiment of the present invention, the filter unit of the water recycling unit can be installed in a number of positions such as within the bottom of the sink, within the drain of the sink or even in between any other device that could be installed at the bottom of a sink (for example a garbage disposal unit) and the eventual drain pipe. A worker skilled in the relevant art would be familiar with numerous positions wherein the filter unit of the present invention could be installed within a sink unit and the drain pipe with our without other devices installed in between the sink and drain pipe.

In a further alternative embodiment of the present invention, the filter unit of the water recycling unit could be a type of filter known in the art that filters all soap product from the existing water such that the water recycling unit would only recirculate clean, fresh water. A worker skilled in the relevant art would appreciate a multitude of different types of filters that would filter out all forms of debris and all forms of contaminants in the water such that only clean water is expelled from the spout.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated invention which is not to be limited to the specific embodiment disclosed.

What is claimed is:

1. A mobile water recycling unit for use with a sink comprising:
a pump having an entry port and an exit port;
an upper tube having a spout operatively connected to the exit port; and
a lower tube having a filter operatively connected to the entry port of the pump,
wherein water travels from the filter to the lower tube, through the pump, into the upper tube and through to the spout.

2. The mobile water recycling unit of claim 1, wherein the upper tube is operatively connected to the exit port through an upper lock nut and a J-tube.

3. The mobile water recycling unit of claim 2, wherein the lower tube is operatively connected to the entry port through a lower lock nut and an L-tube.

4. The mobile water recycling unit of claim 3, further comprising a check valve to allow water to pass through the pump.

5. The mobile water recycling unit of claim 3, further comprising a check valve to preserve water in the pump.

6. The mobile water recycling unit of claim 1, wherein the filter further comprises a filter element to filter smaller debris.

7. The mobile water recycling unit of claim 1, wherein the filter further comprises a filter cage to filter larger debris.

8. The mobile water recycling unit of claim 4, wherein the pump is non-submersible.

9. The mobile water recycling unit of claim 4, wherein the pump is submersible.

10. A water recycling unit for use with a sink comprising:
a pump having an entry port and an exit port;
an upper tube having a spout operatively connected to the exit port; and
a lower tube having a filter operatively connected to the entry port of the pump,
wherein water travels from the filter to the lower tube, through the pump, into the upper tube and through to the spout.

11. The water recycling unit of claim 10, wherein the upper tube is operatively connected to the exit port through an upper lock nut and a J-tube.

12. The water recycling unit of claim 11, wherein the lower tube is operatively connected to the entry port through a lower lock nut and an L-tube.

13. The water recycling unit of claim 12, further comprising a check valve to allow water to pass through the pump.

14. The water recycling unit of claim 13, further comprising a check valve to preserve water in the pump.

15. The water recycling unit of claim 10, wherein the filter further comprises a filter element to filter smaller debris.

16. The water recycling unit of claim 10, wherein the filter further comprises a filter cage to filter larger debris.

17. The water recycling unit of claim 13, wherein the pump is non-submersible.

18. The water recycling unit of claim 13, wherein the pump is submersible.
